(19) United States
(12) Patent Application Publication
(10) Pub. No.: US 2024/0410501 A1
(43) Pub. Date: Dec. 12, 2024

(54) CRIMPED JOINTS FOR CLIMATE CONTROL SYSTEMS

(71) Applicant: Trane International Inc., Davidson, NC (US)

(72) Inventor: Kari Terho, Bullard, TX (US)

(21) Appl. No.: 18/736,954

(22) Filed: Jun. 7, 2024

Related U.S. Application Data
(60) Provisional application No. 63/507,367, filed on Jun. 9, 2023.

(51) Int. Cl. F16L 13/14; F16L 13/16

(52) U.S. Cl. CPC F16L 13/141; F16L 13/161

(57) ABSTRACT

An embodiment of a crimped joint for tubing of a climate control system includes a central axis and a first tube including a throughbore, an outer end, and an annular projection. The projection forms an annular chamber within the throughbore extending radially outward from the central axis. In addition, the joint includes an annular seal member positioned within the annular chamber, and a second tube including an end and a radially outer surface. The end of the second tube is inserted into the throughbore of the first tube such that the annular seal member is engaged with the radially outer surface of the second tube and the second tube axially overlaps with the first tube in a region between the end of the second tube and the annular projection of the first tube along the central axis. Still further, the joint includes one or more crimps positioned within the region.

### CROSS-REFERENCE TO RELATED APPLICATIONS

This application claims priority to and the benefit of U.S. Provisional Patent Application No. 63/507,367 filed Jun. 9, 2023 and entitled “Crimped Joints,” the entire contents of which are incorporated by reference herein for all purposes.

### BACKGROUND

A climate control system, such as a heating, ventilation, and/or air conditioning (HVAC) system may circulate a refrigerant along a circuitous flow path generally between one or more heat exchangers so as to transfer heat between an interior space and an ambient (e.g., outer) environment. The circuitous flow path for the refrigerant may include tubing extending within or between one or more components (e.g., manifolds, heat exchangers, valves, etc.) of the climate control system. The tubing may include various connections or joints throughout the circuitous flow path.

### BRIEF SUMMARY

Some embodiments disclosed herein are directed to a crimped joint for tubing of a climate control system. In some embodiments, the crimped joint includes a central axis and a first tube including a throughbore, an outer end, and an annular projection forming an annular chamber within the throughbore that extends radially outward from the central axis. In addition, the crimped joint includes an annular seal member positioned within the annular chamber. Further, the crimpled joint includes a second tube including an end and a radially outer surface. The end of the second tube is inserted into the throughbore of the first tube such that the annular seal member is engaged with the radially outer surface of the second tube and the second tube axially overlaps with the first tube in a region axially between the end of the second tube and the annular projection of the first tube along the central axis. Still further, the crimpled joint includes one or more crimps positioned within the region.

Some embodiments disclosed herein are directed to a heat exchanger of a climate control system. In some embodiments, the heat exchanger includes a manifold having a main body portion and a plurality of feeder tubes extending from and in fluid communication with the main body portion. Each feeder tube includes a throughbore, an outer distal end opposite of the main body portion along a central axis of the feeder tube, an annular projection forming an annular chamber within the throughbore that extends radially outward from the central axis, and an annular seal member positioned within the annular chamber. In addition, the heat exchanger includes a plurality of heat exchanger tubes at least partially inserted within the plurality of feeder tubes. Each of the plurality of heat exchanger tubes includes an end and a radially outer surface. For each heat exchanger tube of the plurality of heat exchanger tubes: (i) the end of the heat exchanger tube is inserted into the throughbore of a corresponding feeder tube of the plurality of feeder tubes such that the annular seal member of the corresponding feeder tube is engaged with the radially outer surface of the heat exchanger tube, (ii) the heat exchanger tube axially overlaps with the corresponding feeder tube in a region axially between the end of the heat exchanger tube and the annular projection of the corresponding feeder tube along the central axis, and (iii) one or more crimps are formed in the region.

Some embodiments disclosed herein are directed to a method of forming a crimped joint between a first tube and a second tube for channeling refrigerant in a climate control system. In some embodiments, the method includes (a) sizing an outer diameter of the second tube along a portion of the second tube that extends from an end of the second tube. In addition, the method includes (b) inserting the end of the second tube into a throughbore of the first tube along a central axis such that an annular seal member positioned in an annular chamber formed within the throughbore of the first tube is engaged with a radially outer surface of the second tube and the radially outer surface of the second tube overlaps with a radially inner surface of the first tube in a region extending axially between the end of the second tube and the annular seal member. Further, the method includes (c) forming one or more crimps along the region after (b).

Embodiments described herein comprise a combination of features and characteristics intended to address various shortcomings associated with certain prior devices, systems, and methods. The foregoing has outlined rather broadly the features and technical characteristics of at least some of the embodiments disclosed herein in order that the detailed description that follows may be better understood. The various characteristics and features described above, as well as others, will be readily apparent to those having ordinary skill in the art upon reading the following detailed description, and by referring to the accompanying drawings. It should be appreciated that this disclosure may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of various embodiments, reference will now be made to the accompanying drawings in which:

FIG. 1 is a schematic view of a climate control system including tubing having one or more crimped joints according to some embodiments disclosed herein;

FIG. 2 is an enlarged side view of a portion of a heat exchanger of the condenser of the climate control system of FIG. 1 according to some embodiments disclosed herein;

FIGS. 3-8 are sequential side, cross-sectional views of the formation of a crimped joint of the heat exchanger shown in FIG. 2 according to some embodiments disclosed herein;

FIG. 9 is a side, cross-sectional view of an embodiment of a crimped joint for a heat exchanger according to some embodiments disclosed herein;

FIG. 10 is a side view of the crimped joint of FIGS. 3-8 according to some embodiments disclosed herein;

FIG. 11 is another side view of a crimped joint of the heat exchanger of FIG. 2 according to some embodiments disclosed herein; and

FIG. 12 is a side, cross-sectional view of a crimpled joint of the heat exchanger shown in FIG. 2 according to some embodiments.

### DETAILED DESCRIPTION

As previously described, a climate control system may include a circuitous flow path for refrigerant that is at least partially formed from tubing having a number of connections or joints. In some instances, the joints may comprise brazed or welded connections. However, depending on the material of the tubing, a welding or brazing operation may require an excessive amount of time to form a suitable, leak-free connection. For instance, conventional tubing within a climate control system has been largely or entirely constructed from copper; however, alternative materials, such as aluminum, have become more prevalent (e.g., so as to allow the tubing to carry alternative refrigerant formulations). Welding or brazing an aluminum tubing joint is generally more time consuming than a traditional copper joint (e.g., about 15 seconds for aluminum vs 5 seconds for copper for each joint). Thus, there is a desire for improved connection methods for tube connections for a climate control system, and particularly improved connection methods that reduce manufacturing time for a tube joint regardless of the materials utilized.

Accordingly, some embodiments disclosed herein are directed to crimped joints for tubing within a climate control system (or a component thereof) that may be used in place of a brazed or welded connection. In some embodiments, the crimped tube joints may be employed within or proximate to a heat exchanger (such as a condenser or evaporator) of a climate control system; however, use of the embodiments of the crimped joints are contemplated for use throughout a climate control system (and indeed even in outside the climate control system context entirely). Without being limited to this or any other theory, a crimped joint may form a fluid-tight tube connection with a reduced manufacturing time as compared to a conventional welded or brazed connection, especially for alternative tubing materials, such as aluminum. Thus, through use of the embodiments disclosed herein, a total manufacturing time for a tube joint may be reduced.

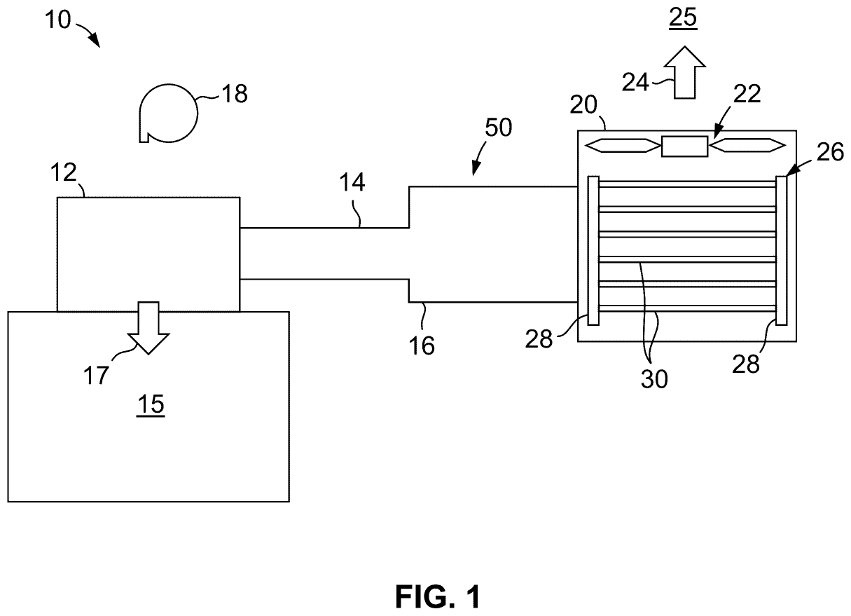

Referring now to FIG. 1, a climate control system 10 (or more simply “system 10”) is shown according to some embodiments. Climate control system 10 generally includes an evaporator 12, a condenser 20, and one or more conduits (or tubing) 14, 16 fluidly coupling the evaporator 12 and condenser 20 together. In some systems 10, the evaporator 12 and the condenser 20 can alternate by reversing flow of refrigerant through the conduits 14, 16. This is commonly known as a heat pump. Climate control system 10 may include additional components that are not shown in FIG. 1 or described in detail herein. The following description of climate control system 10 is meant to provide a broad overview of the components and functionality of the system 10, and one having ordinary skill will appreciate that additional components may be employed within system 10 (e.g., compressors, valves, expanders, etc.).

The evaporator 12, condenser 20, and conduits 14, 16 may form or define a circuitous flow path 50 (or more simply “flow path 50”) for a refrigerant. During operations, the refrigerant may be circulated along the flow path 50 to transfer heat from an interior space 15 to an ambient (e.g., outer) environment 25 or vice versa (e.g., such as in the case of a heat pump). The interior space 15 may include the interior space of a house, dwelling, office building, refrigerator, freezer, storage chamber, or any other suitable space where one may desire to control the environmental conditions thereof.

The evaporator 12 comprises a heat exchanger. During operations, the refrigerant may be expanded and vaporized (e.g., through an expansion valve or other suitable component or system) upstream of the evaporator 12 so that the temperature of the refrigerant is reduced. A blower 18 is configured to induce an airflow 17 over one or more coils or tubes (not shown) of the evaporator 12 that contain the cooled, vaporized refrigerant therein so that heat is transferred from the airflow 17 to the refrigerant within the evaporator 12. The cooled airflow 17 is then directed into the interior space 15.

The refrigerant, now heated as a result of thermal contact with the airflow 17 in the evaporator 12, may be compressed (e.g., via a compressor—not shown) and then flowed along conduit 16 to condenser 20. The condenser 20 comprises a heat exchanger 26 that is configured to transfer heat from the refrigerant to an ambient environment 25 that surrounds the condenser 20. In some embodiments, the condenser 20 is placed outdoors (such as when the climate control system 10 is configured as an air conditioning system for a house, office, or other dwelling), so that the ambient environment 25 comprises the outdoor environment that condenser 20 is placed within. The heat exchanger 26 may include one or more manifolds 28 and tubing 30 that receive and channel the refrigerant therethrough during operations. For example, the manifold 28 may divide the refrigerant received from the conduit into a plurality of paths or “circuits” for heat exchange operation within the condenser 20. A fan assembly 22 may induce an airflow 24 over the manifold(s) 28 and/or tubing 30 so as to transfer heat from the refrigerant to the ambient environment 25. The refrigerant may then be returned from the condenser 20 to the evaporator 12 via the tubing 14 to restart the process described above. In some embodiments, the refrigerant may comprise one or more refrigerants that may comprise hydrofluorocarbons (HFCs), chlorofluorocarbons (CFCs), hydrochlorofluorocarbons (HCFCs), fluorocarbons (FCs), hydrocarbons (HCs), Ammonia (NH₃), carbon dioxide (CO₂), or some combination thereof.

The flow path 50 may include a number of tubing joints or connections between and within the various components of the climate control system 10 (e.g., evaporator 12, condenser 20, etc.). For instance, the heat exchanger 26 of the condenser 20 includes a number of tubing joints, such as between the manifold(s) 28 and tubing 30. Additional details of the tubing joints within the heat exchanger 26 are now described according to some embodiments; however, it should be appreciated that additional tubing joints according to the embodiments disclosed herein may be positioned elsewhere within the climate control system 10 (e.g., within evaporator 12, between evaporator 12, condenser 20, and conduits 14, 16, etc.).

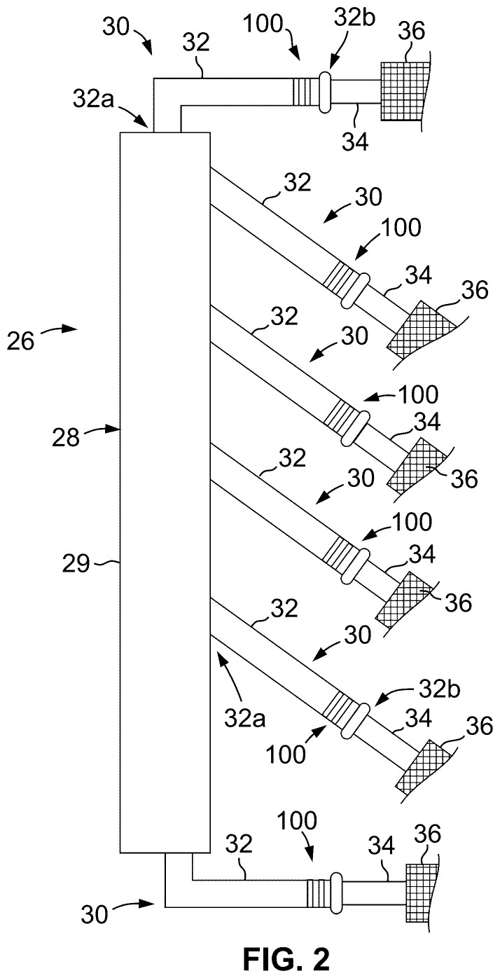

Referring now to FIG. 2, a portion of the heat exchanger 26 of the condenser 20 illustrated in FIG. 1 is shown according to some embodiments. In particular, FIG. 2 illustrates a manifold 28 and a portion of a plurality of tubes 30 connected to the manifold 28 within the heat exchanger 26. The manifold 28 may receive refrigerant (e.g., from an inlet of the condenser 20) and distribute the refrigerant to the plurality of tubes 30 that are exposed to the airflow 24 (FIG. 1) as previously described. The tubes 30 may each include a manifold feeder tube 32 (or more simply “feeder tube 32”) extending from a main body portion 29 of the manifold 28 and a finned tube 34 (or “heat exchanger tube 34”) coupled to the feeder tube 32 via a crimped joint 100 (or more simply “joint 100”). The finned tube 34 may include a plurality of fins 36 that are configured to enhance heat transfer from the refrigerant flowing within the tubes 30 during operations. The plurality of fins 36 may comprise spine fins; however, other fin designs are contemplated (e.g., annular fins, pin fins, rectangular fins, triangular fins, etc.). As is described in more detail below, the fins 36 may be omitted from or removed from an end portion of the finned tube 34 to permit insertion of a bare portion of the tube 34 into the end portion of the feeder tube 34.

The crimped joints 100 may be fluid-tight so that fluids are prevented (or at least restricted) from leaking out from the tubes 30 via the joints 100 during operations. The feeder tubes 32 may each include a first, proximal, or inner end 32a that is connected to the manifold 28 and a second, distal, or outer end 32b that is generally extended away from the manifold 28. The crimped joints 100 may be formed at or proximate to the outer ends 32b of the feeder tubes 32.

In some embodiments, the feeder tubes 32 and/or the finned tubes 34 (and thus also the crimped joints 100) may comprise aluminum. For instance, the feeder tubes 32 and/or the finned tubes 34 may comprise Aluminum 3026; however, other Aluminum alloys and indeed other materials or material combinations are contemplated. In some embodiments, the feeder tubes 32 and/or the finned tubes 34 may comprise copper.

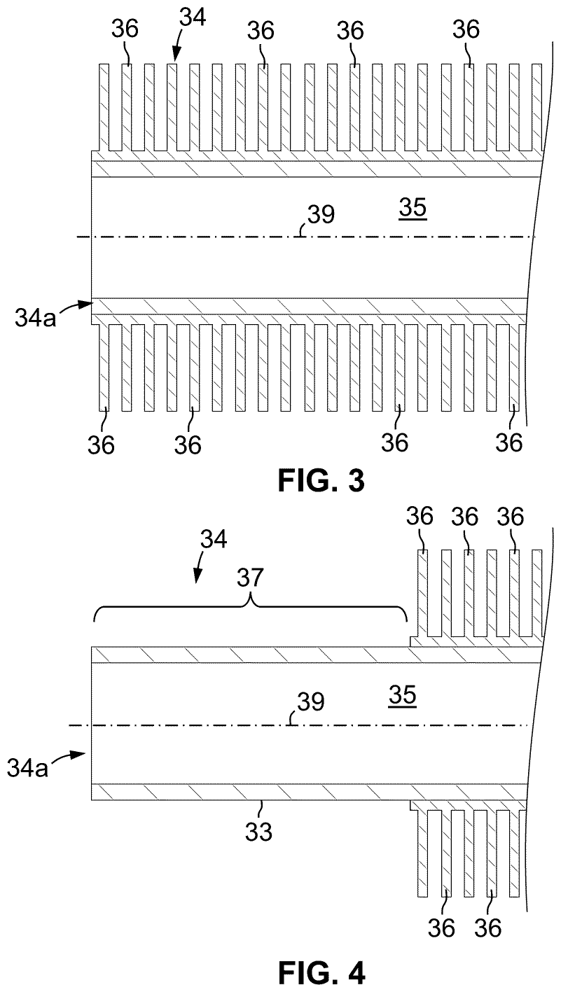

Referring now to FIGS. 3-8, a sequence for forming one of the crimped joints 100 is shown according to some embodiments. It should be appreciated that the sequence shown in FIGS. 3-8 may be applied to form each of the crimped joints 100 shown in FIG. 2. In some embodiments, the sequence shown in FIGS. 3-8 may be performed during the manufacturing of condenser 20 (or other components of climate control system 10) at a manufacturing site.

As shown in FIG. 3, initially, an end 34a of the finned tube 34 may be cut with a suitable tool (e.g., a rotary tool, shears, etc.) so as to provide the desired length of finned tube 34 within the condenser 20 (FIG. 1). The finned tube 34 may include a central or longitudinal axis 39 (or more simply “axis 39”) and a central axially-extending throughbore 35. Thereafter, as shown in FIG. 4, the spine fins 36 may be removed from a portion of the finned tube 34 extending axially (with respect to axis 39) from the end 34a so as to expose a length or portion 37 of bare tubing. For instance, in some embodiments, the spine fins 36 may be attached to the tubing forming the finned tube 34 as an outer layer that may be peeled back or cut away to expose the portion 37 of bare tubing that extends axially from the end 34a. The portion 37 of bare tubing may have a radially outer surface 33.

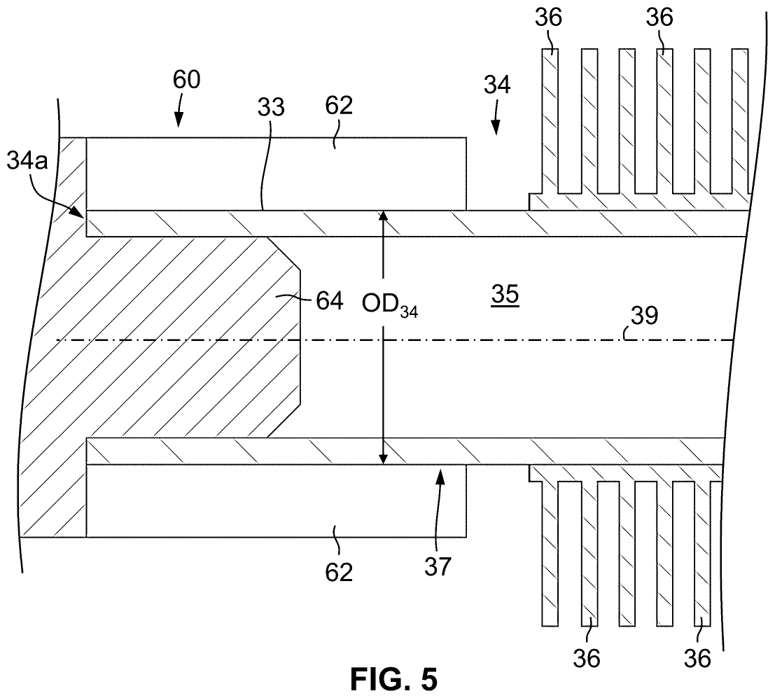

Referring now to FIG. 5, in some embodiments, the radially outer surface 33 of portion 37 of bare tubing (or some portion of the radially outer surface 33) may be shaped (or re-shaped) to facilitate insertion into feeder tube 32 as part of forming the crimped joints 100 (FIG. 2). Specifically, a suitable tool 60 may be used to ensure a desired outer diameter OD₃₄ of the finned tube 34 along the radially outer surface 33 (or portion thereof). In addition, the tool 60 may be used to ensure that the cross-section of the finned tube 34 along the portion 37 is sufficiently round (e.g., that is by ensuring a substantially consistent or uniform outer diameter OD₃₄ about an entire circumference of the finned tuber 34 along portion 37).

In some embodiments, the tool 60 may comprise a rotary tool that includes one or more cutting teeth (or surfaces) 62 that are rotated about the central axis 39 to cut the radially outer surface 33 of the finned tube 34 along portion 37 so as to ensure that the portion 37 has a substantially uniform outer diameter OD₃₄ as previously described. The tool 60 may also include a central mandrel 64 that is inserted into the throughbore 35 of finned tube 34 from end 34a to center or align the tool 60 along the axis 39 during operations. In addition, the mandrel 64 may help to open the throughbore 35 of finned tube 34 at the end 34a (which may have been compressed or pinched when the finned tube 34 was previously cut as shown in FIG. 3).

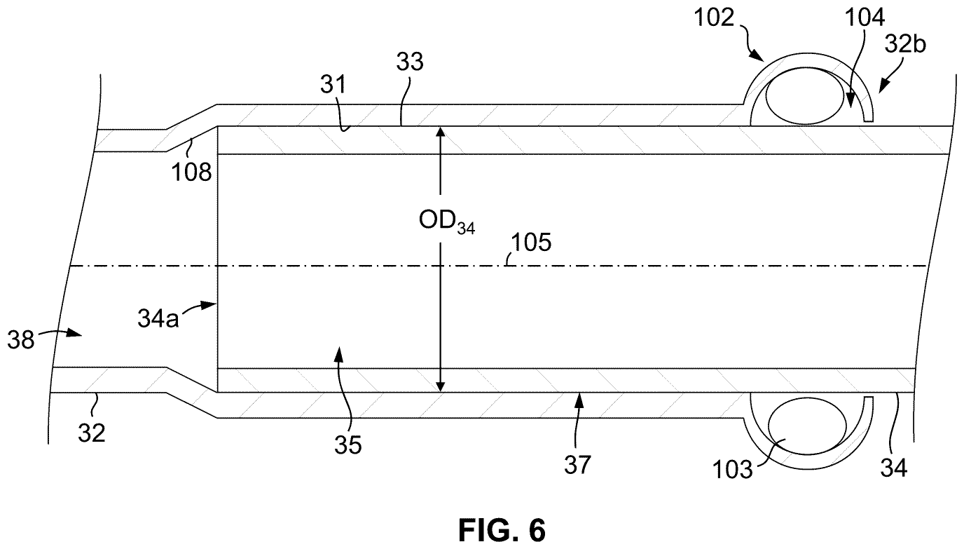

Referring now to FIG. 6, after the finned tube 34 is cut and the outer diameter OD₃₄ of portion 37 is shaped via the tool 60 as previously described (FIGS. 3-5), the end 34a of finned tube 34 is inserted into the outer end 32b of the feeder tube 32 so that the tubes 32, 34 may be substantially, coaxially aligned along a central axis 105 along the portion 37 of bare tubing. The central axis 105 may thus be coaxially aligned with the axis 39 of finned tube 34 along at least the portion 37 of bare tubing. The feeder tube 32 may include a central throughbore 38 having an inner diameter that is slightly larger than the OD₃₄ of finned tube 34 along the portion 37 to allow insertion of the end 34a of finned tube 34 therein. Thus, when the end 34a of the finned tube 34 is inserted into the outer end 32b of the feeder tube 32, the throughbores 38, 35 may be generally aligned with one another along axis 105 and placed in fluid communication with one another.

In some embodiments, the insertion of end 34a of finned tube 34 into the throughbore 38 of feeder tube 32 may be limited by an annular constriction 108 that extends radially inward toward axis 105 within the throughbore 38 and that is axially spaced along the axis 105 from the outer end 32b. In some embodiments, the annular constriction 108 may comprise an internal shoulder or frustoconical surface that is defined within the throughbore 38 and that is formed by radially constricting the inner diameter of the feeder tube 32. In some embodiments, the annular constriction 108 may be formed by crimping (e.g., such as via a crimping tool as described in more detail below) the feeder tube 32. However, it should be appreciated that, in some embodiments, the annular constriction 108 may be omitted.

An annular projection 102 that extends radially outward or away from axis 105 is positioned at (or proximate to) the outer end 32b of the feeder tube 32. In particular, in the embodiment shown in FIG. 6, the annular projection 102 is positioned at the outer end 32b so that the projection 102 at least partially defines the outer end 32b of feeder tube 32. Because the annular projection 102 extends radially outward from axis 105, the projection 102 may form a radially outwardly extending, annular chamber 104 within the throughbore 38.

The outer surface of the annular projection 102 may be generally curved so that the annular projection and the annular chamber 104 may be shaped as a toroid (or may have a toroidal shape). In particular, the annular projection 102, and particularly the annular chamber 104, may comprise a D-shaped toroid that is formed by revolving a D-shaped cross-section circumferentially about the central axis 105. When the annular projection 102 is formed at the outer end 32b of the feeder tube 32, the outer end 32b may be formed by portion of the projection 102 that curves or projects radially inward toward the central axis of the feeder tube 32. However, as described in more detail below, in some embodiments, the annular projection 102 may be axially spaced from the outer end 32b.

The chamber 104 may receive an annular seal member 103, such as an O-ring, therein. As will be described in more detail below, the annular seal member 103 may be compressed against the finned tube 34 (particularly against the radially outer surface 33 of portion 37) to thereby prevent (or at least restrict) fluid flow between the tubes 32, 34 at the crimped joint 100. Thus, in some embodiments, the annular seal member 103 may comprise a compliant material, such as an elastomer.

When the portion 37 of finned tube 34 is inserted into the throughbore 38 of the feeder tube 32 via the outer end 32b, the annular seal member 103 positioned within the chamber 104 may engage (or at least radially oppose) the radially outer surface 33. In addition, when the portion 37 of finned tube 34 is inserted into the throughbore 38 of feeder tube 32, the tubes 32, 34 may axially overlap with one another in a region or portion axially between the end 34a (and constriction 108) and the annular projection 102 (and annular seal member 103). In particular, the tubes 32, 34 may have cylindrical surfaces (specifically, the radially outer surface 33 in the portion 37 of finned tube 34 and a radially inner surface 31 of feeder tube 32) that axially overlap with one another between the end 34a and projection 102.

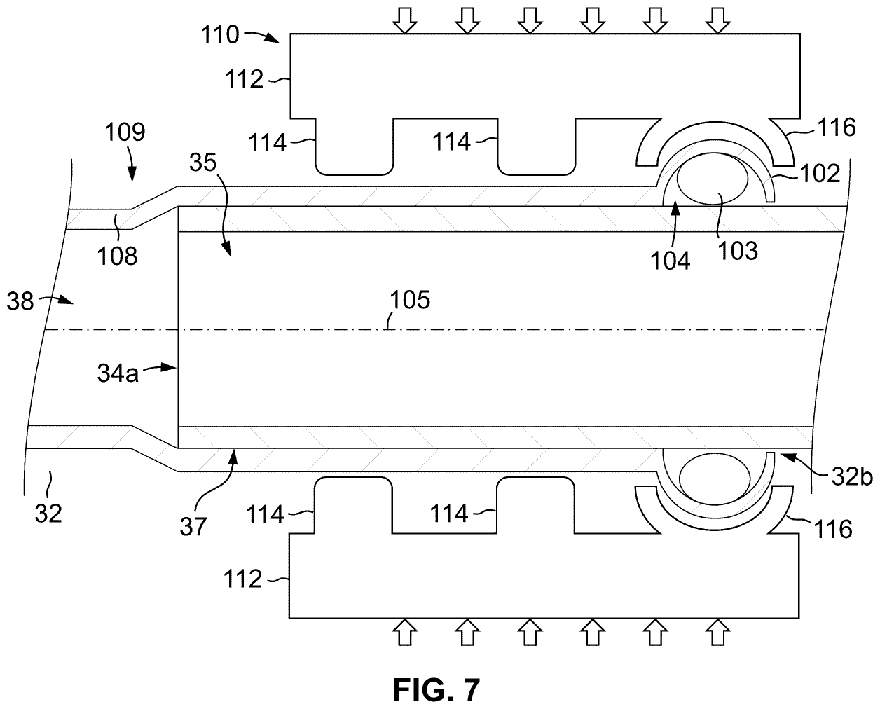

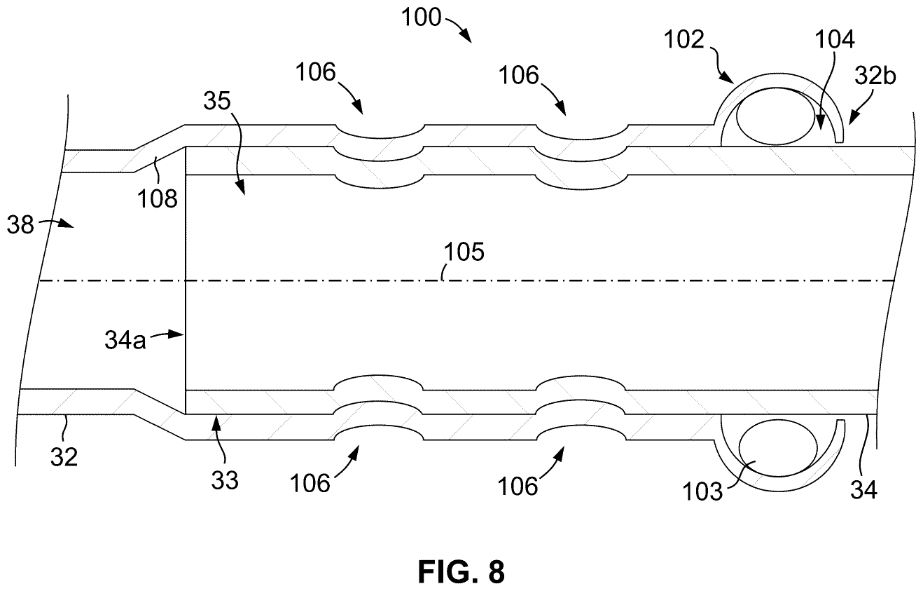

As shown in FIGS. 7 and 8, once the portion 37 of finned tube 34 is inserted into the outer end 32b of the feeder tube 32 as shown in FIG. 6, a crimping tool 110 may annularly compress the axially overlapped tubes to thereby form the crimped joint 100. Specifically, as shown in FIG. 7, the crimping tool 110 may include a set of jaws 112 that include one or more teeth 114 for engaging with and radially compressing the overlapped cylindrical surfaces of the tubes 32, 34 between the end 34a and the projection 102 about the circumference of the tubes 32, 34. The engagement and compression of the jaws 112 with the overlapped cylindrical surfaces of the tubes 32, 34 may locally, plastically deform the tubes 32, 34 so as to form one or more (e.g., two in the embodiment shown in FIGS. 4 and 5), annular crimps or projections 106 that extend radially inward toward the central axis 105. The crimps 106 each may define an annular recess or indentation on the outer surface of the feeder tube 32.

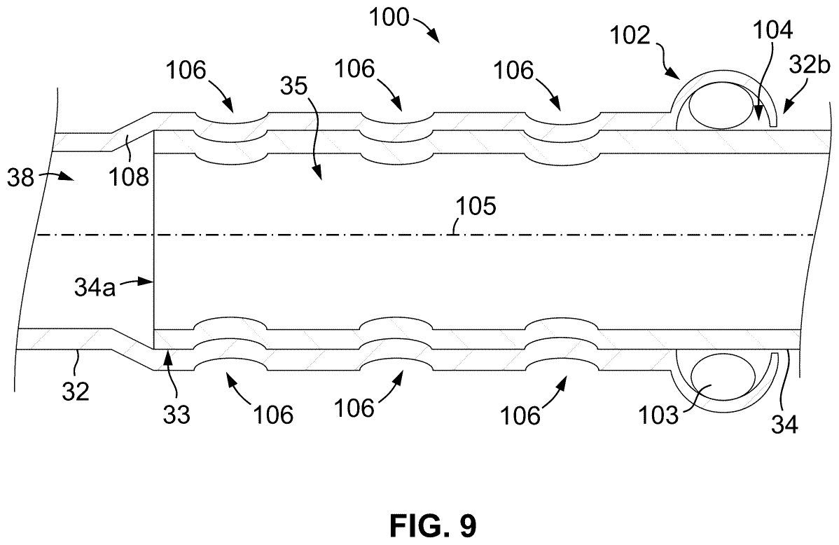

In some embodiments, there may be more than two crimps 106 in the region extending between the end 34a of the finned tube 34 and the annular projection 102. For instance, FIG. 9 shows an embodiment of the crimped joint 100 that includes three crimps 106 in the region extending between the end 34a of the finned tube 34 and the annular projection 102.

In addition, as also shown in FIGS. 7 and 8, in some embodiments, the crimping tool 110 may also include one or more jaws 116 that are configured to engaged with and radially compress the annular projection 102 about the circumference of the tubes 32, 34. Specifically, the engagement of the jaw(s) 116 with the annular projection 102 may radially compress the annular projection 102 toward the axis 105 so as to radially compress the annular seal member 103 against the radially outer surface 33 of the finned tube 34. The engagement between the annular seal member 103 and the radially outer surface 33 of the finned tube 34 may form a fluid-tight seal that prevents (or at least restricts) the flow of fluids between the tubes 32, 34 out of or into the throughbores 38, 35 during operations. The crimps 106 may also prevent (or at least restrict) the flow of fluids between the tubes 32, 34 out of or into the throughbores 38, 35 in some embodiments.

As previously described, the condenser 20 may be positioned outdoors (FIG. 1), and thus, the heat exchanger 26 and the crimped joints 100 thereof may be exposed to the outdoor environment. Thus, in some embodiments, water (e.g., such as from rain, condensation, etc.) may collect between the tubes 32, 34 axially between the annular seal member 103 and the outer end 32b. The collected water may cause corrosion of the tubes 32, 34 overtime, and the corrosion process may be further accelerated if the condenser 20 is positioned in a coastal location, which may have an elevated atmospheric salt content.

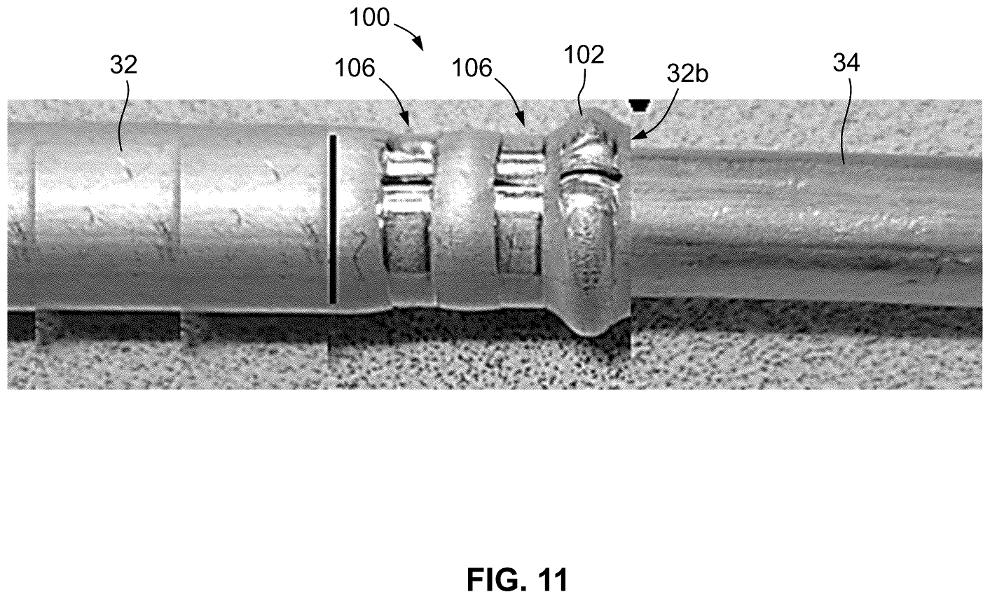

However, because the projection 102 (which receives the annular seal member 103) is positioned at (or near) the outer end 32b of the feeder tube 32, the available volume that may receive collected water from the outer environment may be minimized. Specifically, for the embodiment shown in FIG. 5, the available volume that may collect water between the tubes 32, 34 along crimped joint 100 may comprise the portion of the annular chamber 104 that extends from the annular seal member 103 to the outer end 32b. In some embodiments, the annular projection 102 may be axially spaced along the tube 32 from the outer end 32b such that the feeder tube 32 may include an additional portion (e.g., a cylindrical portion) or length extending from the annular projection 102 to the outer end 32b (FIG. 11 and the associated text herein). However, in at least some of these embodiments, the additional portion or length may be minimized in axial length so as to minimize the available volume between the tubes 32, 34 that may collect water during operations. In addition, referring briefly again to FIG. 2, one or more (e.g., all, less than all, etc.) of the feeder tubes 32 may be angled vertically downward so as to shed any water away from the crimped joint 100 via the force of gravity so as to prevent water accumulation between the tubes 32, 34. However, it should be appreciated that in some embodiments, the feeder tubes 32 may extend horizontally or laterally away from the main body portion 29 and thus may not be angled vertically downward.

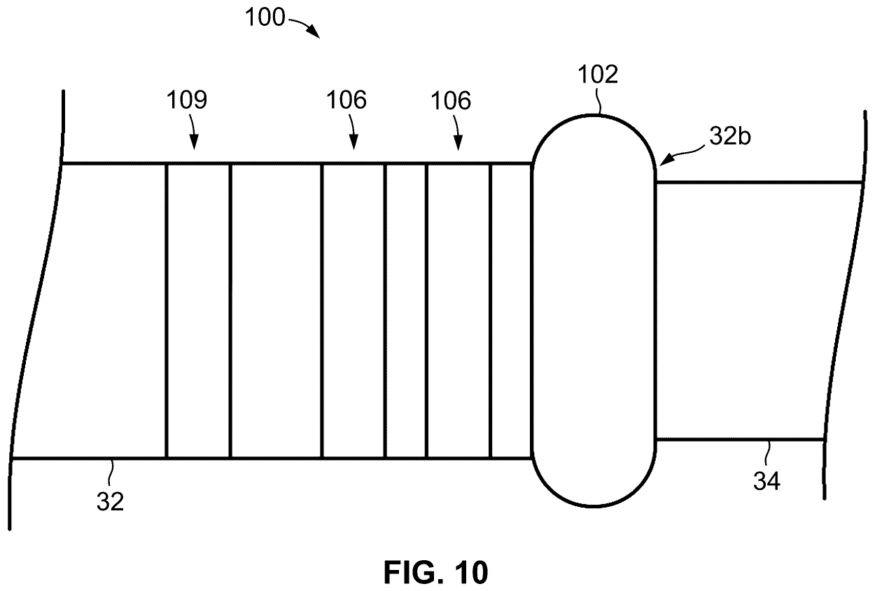

FIGS. 10 and 11 show external views of embodiments of the crimped joint 100 illustrated in FIG. 8. As may be appreciated from FIGS. 10 and 11 (and particularly FIG. 11), the crimps 106 may be visible from the outer surface of the feeder tube 32 due to the plastic deformation caused by the crimping tool 110 (FIG. 7) during operations.

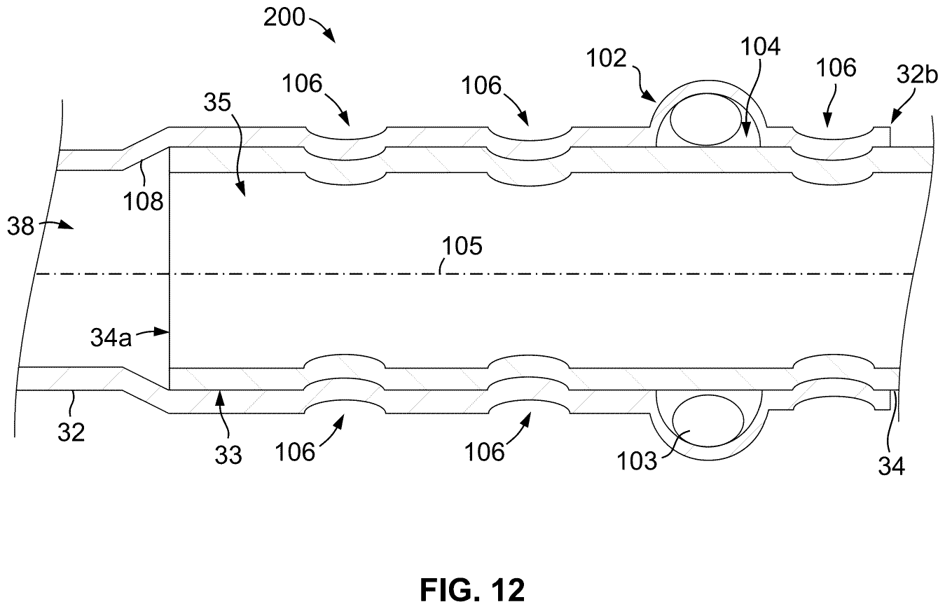

Referring now to FIG. 12, a side, cross-sectional view of another embodiment of a crimped joint 200 that may be used in the heat exchanger 26 (or elsewhere in the climate control system 10 as previously described) in place of one or more of the crimped joints 100 (FIG. 2) is shown. The crimped joint 200 may be substantially the same as the crimped joint 100 (FIG. 8) previously described. Thus, in FIG. 12, the same reference numerals are used to designate features of the crimped joint 200 that are shared with the crimped joint 100, and the description of crimped joint 200 herein will focus on the features of crimped joint 200 that are different from those of crimped joint 100.

In particular, the crimped joint 200 includes an additional annular crimp 206 that is positioned axially between the annular projection 102 and the outer end 32b of feeder tube 32. The crimp 206 may be similar to the crimps 106, previously described. Thus, the crimp 206 may define an annular recess or indentation on the outer surface of the feeder tube 32. As previously described for the crimped joint 100 (FIGS. 8 and 9), there may be two crimps 106 between the end 34a of the finned tube 34 and the annular projection 102 (such as shown in FIG. 8), three crimps 106 between the end 34a of the finned tube 34 and the annular projection 102 (such as shown for in FIG. 9), or another number of crimps 106 between the end 34a of the finned tube 34 and the annular projection 102 (e.g., such less than two or more than three crimps 106).

As may be appreciated from FIG. 12, the annular projection 102 may be axially spaced (along axis 105) from the outer end 32b to provide sufficient space to form the crimp 206. Without being limited to this or any other theory, spacing the annular projection 102 from the outer end 32b may help to guide the portion 37 of finned tube 34 axially into the feeder tube 32 and thereby prevent damage of the annular seal member 103 or dislodgement of the annular seal member 103 from the annular chamber 104 when inserting portion 37 of finned tubing 34 into feeder tube 32. In addition, adding an additional crimp 206 may also increase a tensile strength of the crimped joint 200 so that a risk of axial separation of the feeder tube 32 and finned tube 34 via crimped joint 200 is reduced.

As explained above and reiterated below, the present disclosure includes, without limitation, the following example implementations.

Clause 1: A crimped joint for tubing of a climate control system, the crimped joint comprising: a central axis; a first tube including: a throughbore; an outer end; and an annular projection forming an annular chamber within the throughbore that extends radially outward from the central axis; an annular seal member positioned within the annular chamber; a second tube including: an end; and a radially outer surface; wherein the end of the second tube is inserted into the throughbore of the first tube such that the annular seal member is engaged with the radially outer surface of the second tube and the second tube axially overlaps with the first tube in a region axially between the end of the second tube and the annular projection of the first tube along the central axis; and one or more crimps positioned within the region.

Clause 2: The crimped joint of any of the clauses, wherein at least one of the first tube or the second tube comprises aluminum.

Clause 3: The crimped joint of any of the clause, wherein the one or more crimps comprises two crimps positioned within the region.

Clause 4: The crimped joint of any of the clauses, wherein the first tube comprises one feeder tube of a plurality of feeder tubes extending from a manifold.

Clause 5: The crimped joint of any of the clauses, wherein the second tube comprises a finned tube including a plurality of spine fins.

Clause 6: The crimped joint of any of the clauses, wherein the annular projection is positioned at the outer end of the first tube.

Clause 7: The crimpled joint of any of the clauses, wherein the annular projection is spaced from the outer end of the first tube, and wherein the crimped joint further comprises an additional crimp positioned axially between the annular projection and the outer end.

Clause 8: The crimpled joint of any of the clauses, wherein the annular seal member comprises an O-ring.

Clause 9: A heat exchanger of a climate control system, the heat exchanger comprising: a manifold having a main body portion; and a plurality of feeder tubes extending from and in fluid communication with the main body portion; wherein each feeder tube comprises: a throughbore; an outer distal end opposite of the main body portion along a central axis of the feeder tube, an annular projection forming an annular chamber within the throughbore that extends radially outward from the central axis; and an annular seal member positioned within the annular chamber; and a plurality of heat exchanger tubes at least partially inserted within the plurality of feeder tubes, wherein each of the plurality of heat exchanger tubes comprises: an end; and a radially outer surface; wherein for each heat exchanger tube of the plurality of heat exchanger tubes: the end of the heat exchanger tube is inserted into the throughbore of a corresponding feeder tube of the plurality of feeder tubes such that the annular seal member of the corresponding feeder tube is engaged with the radially outer surface of the heat exchanger tube, the heat exchanger tube axially overlaps with the corresponding feeder tube in a region axially between the end of the heat exchanger tube and the annular projection of the corresponding feeder tube along the central axis, and one or more crimps are formed in the region.

Clause 10: The heat exchanger of any of the clauses, wherein the plurality of feeder tubes and the plurality of heat exchanger tubes comprise aluminum.

Clause 11: The heat exchanger of any of the clauses, wherein for each heat exchanger tube of the plurality of heat exchanger tubes, the one or more crimps comprises two crimps positioned within the region.

Clause 12: The heat exchanger of any of the clauses, wherein each heat exchanger tube comprises a finned tube including a plurality of spine fins.

Clause 13: The heat exchanger of any of the clauses, wherein the annular projection of each feeder tube of the plurality of feeder tubes is positioned at the outer distal end.

Clause 14: The heat exchanger of any of the clauses, wherein the annular projection of each feeder tube of the plurality of feeder tubes is spaced from the outer distal end, and wherein each feeder tube includes an additional crimp that is positioned axially between the annular projection and the outer distal end.

Clause 15: A method of forming a crimped joint between a first tube and a second tube for channeling refrigerant in a climate control system, the method comprising: (a) sizing an outer diameter of the second tube along a portion of the second tube that extends from an end of the second tube; (b) inserting the end of the second tube into a throughbore of the first tube along a central axis such that an annular seal member positioned in an annular chamber formed within the throughbore of the first tube is engaged with a radially outer surface of the second tube and the radially outer surface of the second tube overlaps with a radially inner surface of the first tube in a region extending axially between the end of the second tube and the annular seal member; and (c) forming one or more crimps along the region after (b).

Clause 16: The method of any of the clauses, wherein (a) comprises shaping the radially outer surface of the second tube in the region to have a substantially uniform outer diameter along an entire circumference of the second tube.

Clause 17: The method of any of the clauses, wherein the second tube includes a plurality of spine fins, and wherein the method further comprises: (d) removing the spine fins from the radially outer surface along the portion before (a).

Clause 18: The method of any of the clauses, wherein (a) comprises cutting the radially outer surface of the second tube with a rotary tool.

Clause 19: The method of any of the clauses, wherein the annular chamber is positioned at an outer end of the first tube, and wherein the method further comprises: (e) radially compressing an annular projection forming the annular chamber to compress the annular seal member into the radially outer surface of the second tube after (b).

Clause 20: The method of any of the clauses, wherein the annular chamber is spaced from an outer end of the first tube, and wherein the method further comprises: (f) forming an additional crimp axially between the annular chamber and the outer end of the first tube after (b).

The embodiments disclosed herein include crimped joints for the tubing of a climate control system (or a component thereof) that may be used in place of a brazed or welded connection. As previously described, a crimped joint according to the embodiments disclosed herein may form a fluid-tight tube connection with a reduced manufacturing time as compared to a conventional welded or brazed connection. Thus, through use of the embodiments disclosed herein, a total manufacturing time for a tube joint may be reduced, even when the tubing is constructed of alternative materials (such as aluminum).

The preceding discussion is directed to various exemplary embodiments. However, one of ordinary skill in the art will understand that the examples disclosed herein have broad application, and that the discussion of any embodiment is meant only to be exemplary of that embodiment, and not intended to suggest that the scope of the disclosure, including the claims, is limited to that embodiment.

The drawing figures are not necessarily to scale. Certain features and components herein may be shown exaggerated in scale or in somewhat schematic form and some details of conventional elements may not be shown in interest of clarity and conciseness.

In the discussion herein and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a given axis (e.g., central axis of a body or a port), while the terms “radial” and “radially” generally mean perpendicular to the given axis. For instance, an axial distance refers to a distance measured along or parallel to the axis, and a radial distance means a distance measured perpendicular to the axis. Further, when used herein (including in the claims), the words “about,” “generally,” “substantially,” “approximately,” and the like, when used in reference to a stated value mean within a range of plus or minus 10% of the stated value.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A crimped joint for tubing of a climate control system, the crimped joint comprising:
a central axis;
a first tube including:
a throughbore;
an outer end; and
an annular projection forming an annular chamber within the throughbore that extends radially outward from the central axis;
an annular seal member positioned within the annular chamber;
a second tube including:
an end; and
a radially outer surface;
wherein the end of the second tube is inserted into the throughbore of the first tube such that the annular seal member is engaged with the radially outer surface of the second tube and the second tube axially overlaps with the first tube in a region axially between the end of the second tube and the annular projection of the first tube along the central axis; and
one or more crimps positioned within the region.

2. The crimped joint of claim 1, wherein at least one of the first tube or the second tube comprises aluminum.

3. The crimped joint of claim 1, wherein the one or more crimps comprises two crimps positioned within the region.

4. The crimped joint of claim 1, wherein the first tube comprises one feeder tube of a plurality of feeder tubes extending from a manifold.

5. The crimped joint of claim 1, wherein the second tube comprises a finned tube including a plurality of spine fins.

6. The crimped joint of claim 1, wherein the annular projection is positioned at the outer end of the first tube.

7. The crimped joint of claim 1, wherein the annular projection is spaced from the outer end of the first tube, and wherein the crimped joint further comprises an additional crimp positioned axially between the annular projection and the outer end.

8. The crimped joint of claim 1, wherein the annular seal member comprises an O-ring.

9. A heat exchanger of a climate control system, the heat exchanger comprising:
a manifold having a main body portion; and
a plurality of feeder tubes extending from and in fluid communication with the main body portion;
wherein each feeder tube comprises:
a throughbore;
an outer distal end opposite of the main body portion along a central axis of the feeder tube,
an annular projection forming an annular chamber within the throughbore that extends radially outward from the central axis; and
an annular seal member positioned within the annular chamber; and
a plurality of heat exchanger tubes at least partially inserted within the plurality of feeder tubes, wherein each of the plurality of heat exchanger tubes comprises:
an end; and
a radially outer surface;
wherein for each heat exchanger tube of the plurality of heat exchanger tubes:
the end of the heat exchanger tube is inserted into the throughbore of a corresponding feeder tube of the plurality of feeder tubes such that the annular seal member of the corresponding feeder tube is engaged with the radially outer surface of the heat exchanger tube,
the heat exchanger tube axially overlaps with the corresponding feeder tube in a region axially between the end of the heat exchanger tube and the annular projection of the corresponding feeder tube along the central axis, and
one or more crimps are formed in the region.

10. The heat exchanger of claim 9, wherein the plurality of feeder tubes and the plurality of heat exchanger tubes comprise aluminum.

11. The heat exchanger of claim 9, wherein for each heat exchanger tube of the plurality of heat exchanger tubes, the one or more crimps comprises two crimps positioned within the region.

12. The heat exchanger of claim 9, wherein each heat exchanger tube comprises a finned tube including a plurality of spine fins.

13. The heat exchanger of claim 9, wherein the annular projection of each feeder tube of the plurality of feeder tubes is positioned at the outer distal end.

14. The heat exchanger of claim 9, wherein the annular projection of each feeder tube of the plurality of feeder tubes is spaced from the outer distal end, and wherein each feeder tube includes an additional crimp that is positioned axially between the annular projection and the outer distal end.

15. A method of forming a crimped joint between a first tube and a second tube for channeling refrigerant in a climate control system, the method comprising:
(a) sizing an outer diameter of the second tube along a portion of the second tube that extends from an end of the second tube;
(b) inserting the end of the second tube into a throughbore of the first tube along a central axis such that an annular seal member positioned in an annular chamber formed within the throughbore of the first tube is engaged with a radially outer surface of the second tube and the radially outer surface of the second tube overlaps with a radially inner surface of the first tube in a region extending axially between the end of the second tube and the annular seal member; and
(c) forming one or more crimps along the region after (b).

16. The method of claim 15, wherein (a) comprises shaping the radially outer surface of the second tube in the region to have a substantially uniform outer diameter along an entire circumference of the second tube.

17. The method of claim 16, wherein the second tube includes a plurality of spine fins, and wherein the method further comprises:
(d) removing the spine fins from the radially outer surface along the portion before (a).

18. The method of claim 17, wherein (a) comprises cutting the radially outer surface of the second tube with a rotary tool.

19. The method of claim 15, wherein the annular chamber is positioned at an outer end of the first tube, and wherein the method further comprises:
(e) radially compressing an annular projection forming the annular chamber to compress the annular seal member into the radially outer surface of the second tube after (b).

20. The method of claim 15, wherein the annular chamber is spaced from an outer end of the first tube, and wherein the method further comprises:
(f) forming an additional crimp axially between the annular chamber and the outer end of the first tube after (b).
